(19) United States
(12) Patent Application Publication
(10) Pub. No.: US 2011/0146917 A1
(43) Pub. Date: Jun. 23, 2011

(54) METHOD AND APPARATUS OF DISMANTLING PLASMA DISPLAY DEVICE

(76) Inventor: Hiroshi IWAMOTO, Osaka (JP)

(21) Appl. No.: 12/971,572

(22) Filed: Dec. 17, 2010

(30) Foreign Application Priority Data
Dec. 22, 2009 (JP) 2009-290074

(51) Int. Cl. B32B 38/10

(52) U.S. Cl. 156/711; 156/752; 156/924

(57) ABSTRACT

A method of dismantling a plasma display device including a plasma display panel unit produced by bonding a plasma display panel to a support member through a bonding member, where the bonding member of the plasma display device unit is heated when the plasma display panel is peeled off from the support member, in a state in which either one of the plasma display panel and the support member is fixed and the other is undergoing an urging force in a direction such that the plasma display panel is peeled off from the support member.

### TECHNICAL FIELD

The technology disclosed herein relates to a method and an apparatus of dismantling a plasma display device, those peeling off the plasma display panel from the metal support plate.

### BACKGROUND ART

In recent years, a large number of plasma display devices including plasma display panels (abbreviated as PDP hereinafter) have been manufactured and sold as display devices suitable for slimming down and upsizing.

With a large number of plasma display devices (abbreviated as PDP device, hereinafter) prevailing, used PDP devices are expected to be collected in a rapidly growing number. Meanwhile, reusing parts and materials of PDP devices is requested from the aspect of environmental issues and resource saving. Under the circumstances, it is important to dismantle parts and materials of PDP devices at low cost in an easily reusable form.

For example, patent literature 1 (Japanese Patent Unexamined Publication No. 2005-116346) discloses the following method. That is, a PDP device is heated at its panel side by a hotplate to separate the panel from the chassis as a support member, where the chassis is pulled after heating to be separated from the panel.

### SUMMARY OF THE INVENTION

The method of dismantling a plasma display device disclosed herein is for dismantling a plasma display device including a plasma display panel unit produced by bonding a plasma display panel to a support member through a bonding member, where the bonding member of the plasma display device unit is heated when the plasma display panel is peeled off from the support member, in a state in which either one of the plasma display panel and the support member is fixed and the other is undergoing an urging force in a direction such that the plasma display panel is peeled off from the support member.

The apparatus of dismantling a plasma display device disclosed herein is for dismantling a plasma display device including a plasma display panel unit produced by bonding a plasma display panel to a support member through a bonding member, where the apparatus includes a separating device in which the plasma display panel unit is placed; and a heating device for heating the bonding member of the plasma display panel unit placed in the separating device. Further, the separating device includes a holding base for holding either one of the plasma display panel and the support member; and an urging means for exerting an urging force on the other in a direction such that the plasma display panel is peeled off from the support member. The heating device heats the bonding member of the plasma display device unit in a state in which the plasma display panel unit is placed in the separating device by fixing either one of the plasma display panel and the support member to the holding base and by attaching the urging means to the other.

### BRIEF DESCRIPTION OF DRAWINGS

FIG. 1 is an exploded perspective view showing the general configuration of a PDP device used in the dismantling method according to one exemplary embodiment.

FIG. 2 is an outline block diagram showing a dismantling apparatus used in the dismantling method according to one exemplary embodiment.

FIGS. 3A, 3B, and 3C are outline block diagrams for illustrating the dismantling method using the dismantling apparatus.

FIG. 4 is an outline block diagram showing a dismantling apparatus according to another exemplary embodiment.

FIG. 5 is an outline block diagram showing a dismantling apparatus according to yet another exemplary embodiment.

FIGS. 6A and 6B are outline block diagrams for illustrating the dismantling method using the dismantling apparatus.

FIG. 7 is an outline block diagram showing a dismantling apparatus according to still another exemplary embodiment.

FIGS. 8A and 8B are outline block diagrams for illustrating the dismantling method according to further another exemplary embodiment.

### DETAILED DESCRIPTION OF PREFERRED EMBODIMENT

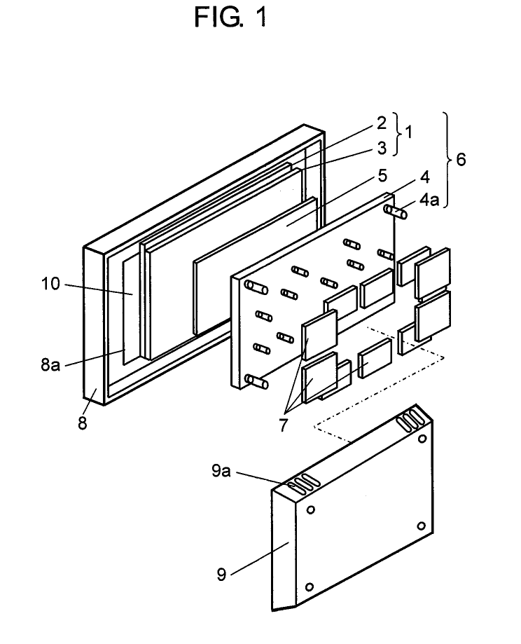

FIG. 1 shows the general configuration of a PDP device used in the dismantling method according to one exemplary embodiment. In FIG. 1, PDP 1 is composed of front panel 2 and back panel 3. PDP 1 is held by being bonded onto the front surface of chassis 4, made of such as aluminum, as a support member for holding the back surface of PDP 1, through sheet 5 as a thermally conductive, elastic bonding member. PDP 1, chassis 4, and sheet 5 compose PDP unit 6. Sheet 5 efficiently conducts heat generated in PDP 1 to discharge the heat.

The back surface of chassis 4 has plural circuit blocks 7 for display-driving PDP 1 attached thereon. Each circuit block 7 includes an electric circuit for display-driving and controlling PDP 1 and electrically connected to an electrode lead extracted to the edge of PDP 1 by means of plural flexible wiring boards (not shown) extending beyond the end of chassis 4.

The casing containing PDP unit 6 is composed of front frame 8 and metal back cover 9. Front frame 8 is provided therein with opening 8a smaller than the outside dimensions of PDP 1 and larger than the display area of PDP 1. Front frame 8 has front cover glass 10 for protecting PDP 1, and front cover glass 10 has an optical filter. The optical filter is provided with an unnecessary radiation suppressing film (produced by such as silver deposition) for suppressing unnecessary radiation of electromagnetic waves.

Further, back cover 9 is provided therein with plural air holes 9a for discharging heat generated in PDP 1 and other parts to the outside. The back surface of chassis 4 has bosses 4a disposed thereon for fixing circuit blocks 7 and back cover 9 by fastening fixing pins on an aluminum plain plate.

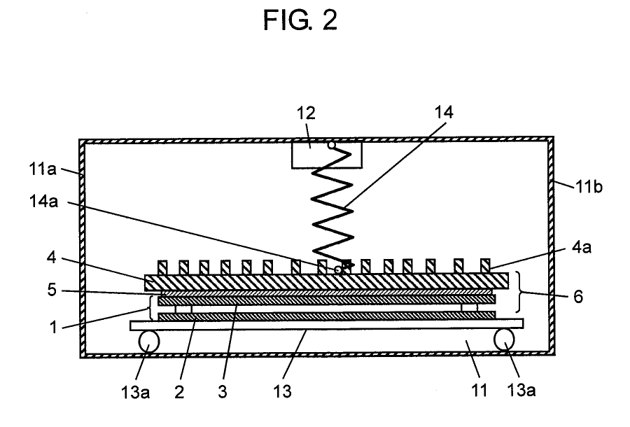

Next, a description is made of the method and an apparatus of dismantling the plasma display panel unit of a PDP device using FIGS. 2 through 8.

First, the method of dismantling a PDP device according to one exemplary embodiment is as follows. That is, parts and materials are collected from a PDP device discarded because of such as defective production and the product lifetime. After that, when peeling off PDP 1 from chassis 4 as a support member, sheet 5 as a bonding member of PDP unit 6 is heated in a state in which either one of PDP 1 and chassis 4 is fixed and the other is undergoing an urging force caused by elastic weighting in a direction such that PDP 1 is peeled off from chassis 4. Here, PDP unit 6 is heated at a temperature depending on the material of adhesive sheet 5. When sheet 5 as a bonding member is heated to a temperature at which sheet 5 softens (e.g. approximately 200° C. for a bonding member primarily containing such as acrylic copolymer), sheet 5 softens and its adhesivity decreases, thereby allowing PDP 1 to be peeled off from chassis 4 easily.

FIG. 2 shows an outline structure of a dismantling apparatus used in the dismantling method according to one exemplary embodiment. As shown in FIG. 2, the apparatus includes separating device 11 in which PDP unit 6 is placed; and heating device 12 (e.g. a heater) for heating sheet 5 of PDP unit 6 placed in separating device 11.

Separating device 11 includes holding base 13 for holding PDP 1; and pulling spring 14 one end of which is fixed to the top surface of body unit casing 11a of separating device 11, and the end of which has fastening fitting 14a attached thereto for fastening pulling spring 14 to chassis 4 of PDP unit 6. In other words, pulling spring 14 of separating device 11 functions as an urging means for exerting an urging force caused by elastic weighting on chassis 4 in a direction such that PDP 1 is peeled off from chassis 4, by fastening fitting 14a at the end fastened to chassis 4 of PDP unit 6. The bottom surface of holding base 13 is provided thereon with rotating roller 13a so as to be easily installed in body unit casing 11a of separating device 11 in a state in which PDP unit 6 is placed on holding base 13. Further, one surface of body unit casing 11a of separating device 11 is provided with open/close door 11b, allowing holding base 13 with PDP unit 6 placed thereon to be contained in body unit casing 11a of separating device 11 by opening and closing door 11b.

Heating device 12 is placed on the top surface inside body unit casing 11a of separating device 11 to heat PDP unit 6 from the side of chassis 4. As a result, the dismantling apparatus shown in FIG. 2 as an example has heating device 12 attached to the inside of body unit casing 11a of separating device 11 to increase the temperature inside body unit casing 11a of separating device 11 to a level at which sheet 5 as a bonding member softens. For this reason, the wall surface of body unit casing 11a of separating device 11 is formed of a heat-resistant insulator.

Here, in the example shown in FIG. 2, PDP 1 of PDP unit 6 is fixed to holding base 13 of separating device 11 to exert an urging force caused by pulling spring 14 on chassis 4. Instead, chassis 4 may be fixed to holding base 13 to exert an urging force caused by pulling spring 14 on PDP 1.

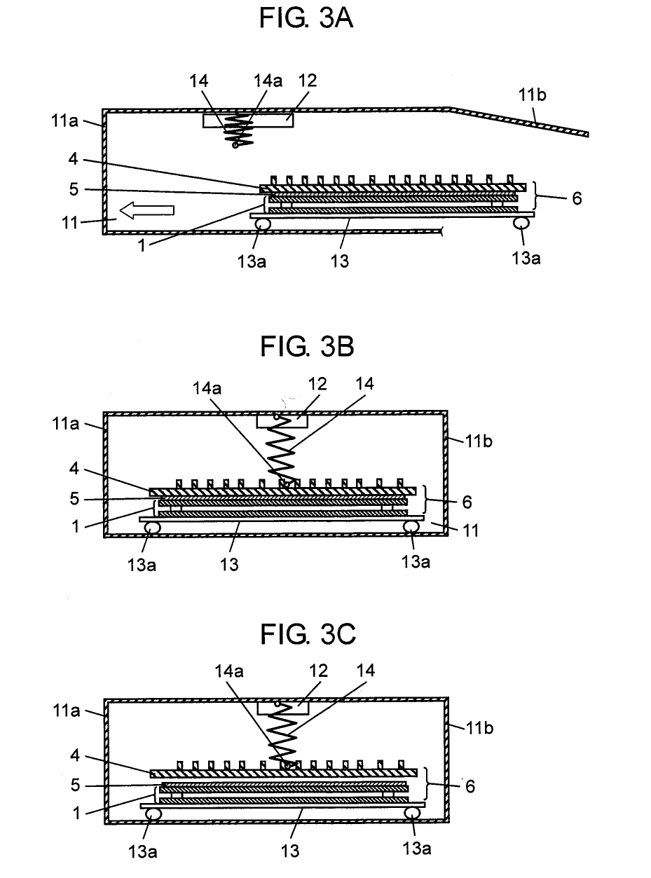

Next, a description is made of the dismantling method using the dismantling apparatus shown in FIG. 2 using FIGS. 3A through 3C.

First, as shown in FIG. 3A, PDP unit 6 is fixed to holding base 13 at the side of PDP 1, and PDP unit 6 together with holding base 13 is placed inside body unit casing 11a of separating device 11. After that, as shown in FIG. 3B, fastening fitting 14a at the end of pulling spring 14 is attached to chassis 4 of PDP unit 6, and then door 11b is closed to complete setting of PDP unit 6.

After that, heating device 12 increases the temperature inside body unit casing 11a of separating device 11 in the state of FIG. 3B. At this moment, when the temperature inside separating device 11 rises to approximately 200° C., sheet 5 (e.g. with an adhesive primarily containing such as acrylic copolymer used) starts to decrease its adhesivity.

As a result that heating device 12 heats sheet 5 of PDP unit 6, the adhesivity of sheet 5 bonding PDP 1 to chassis 4 decreases, and when a peeling force by pulling spring 14 exceeds the adhesivity of sheet 5, chassis 4 is peeled off as shown in FIG. 3C, which completes separating of PDP 1 of PDP unit 6 from chassis 4. After that, door 11b of separating device 11 is opened, and separated PDP 1 and chassis 4 are extracted from the inside of body unit casing 11a, which complete the dismantling process.

After the dismantling process, PDP 1 is separated into front panel 2 and back panel 3; PDP constituent materials such as a phosphor are removed from the glass substrate; the glass substrate is crushed to be used for glass material. Meanwhile, chassis 4 made of such as aluminum is to be used as metallic material.

In the above description, PDP 1 is fixed onto holding base 13 of separating device 11, where PDP 1 does not need to be fixed tightly, but may be held lightly on holding base 13. The point is, PDP 1 has only to undergo a holding force strong enough so as not to be pulled together with chassis 4 when sheet 5 of PDP unit 6 is heated to decrease the adhesivity of sheet 5 and chassis 4 is peeled off, where the self weight of PDP 1 may be used for the holding force.

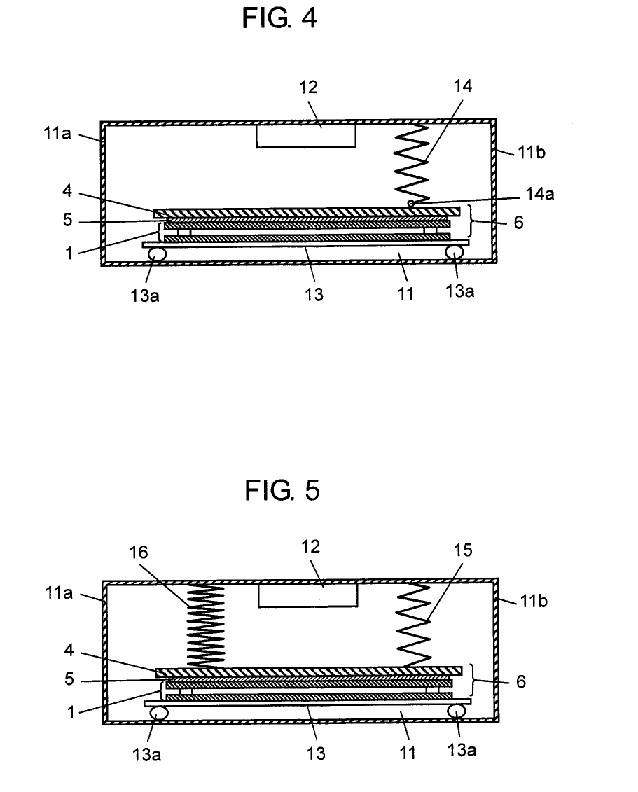

In separating device 11 shown in FIG. 2, fastening fitting 14a at the end of pulling spring 14 is attached to the roughly central part of chassis 4. Instead, as shown in FIG. 4, fastening fitting 14a of pulling spring 14 may be attached to the end of chassis 4. In this case, the end of chassis 4 undergoes an urging force in a direction such that PDP 1 is peeled off from chassis 4. Consequently, the adhesivity of sheet 5 bonding PDP 1 to chassis 4 decreases, and when a peeling force by pulling spring 14 becomes stronger than the adhesivity of sheet 5, chassis 4 is peeled off in a way chassis 4 is rotated with its one end being a supporting point.

Further, as shown in FIG. 5, separating device 11 may be provided with elastic urging means for exerting different urging forces caused by weighting, at both ends of chassis 4. Concretely, pulling springs 15 and 16 with different spring constants as urging means (i.e. pulling spring 15 with a larger spring constant and pulling spring 16 with a smaller one) are attached at both ends of chassis 4. Consequently, the adhesivity of sheet 5 bonding PDP 1 to chassis 4 decreases, and when a peeling force by pulling spring 15 becomes stronger than the adhesivity of sheet 5, chassis 4 is peeled off in a way chassis 4 is rotated with its one end close to the pulling spring 16 being a supporting point.

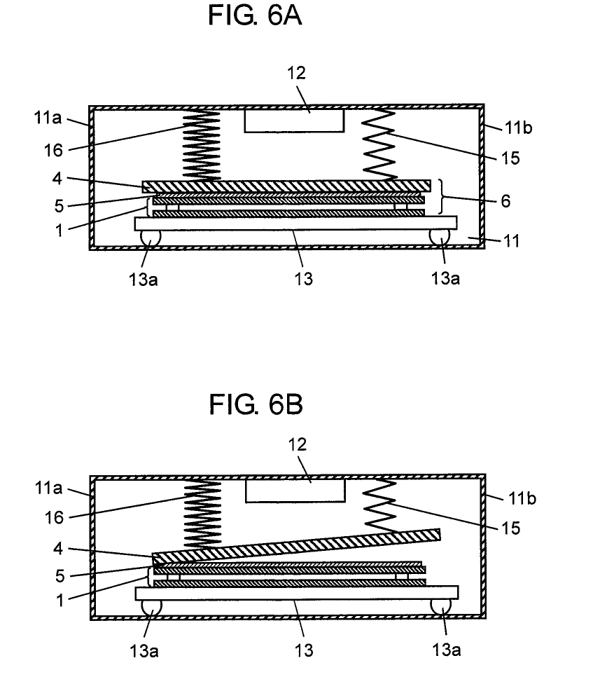

FIGS. 6A and 6B are outline block diagrams showing operation of the dismantling apparatus of FIG. 5.

As shown in FIG. 6A, PDP unit 6 (the side of PDP 1) is fixed to holding base 13, and PDP unit 6 together with holding base 13 is placed inside body unit casing 11a of separating device 11. After that, the ends of pulling springs 15 and 16 are attached to chassis 4 of PDP unit 6, and then heating device 12 increases the temperature inside body unit casing 11a of separating device 11 in the state of FIG. 6A. As a result that heating device 12 heats sheet 5 of PDP unit 6, the adhesivity of sheet 5 bonding PDP 1 to chassis 4 decreases, and when a peeling force by pulling spring 15 exceeds the adhesivity of sheet 5, chassis 4 is peeled off in a way chassis 4 is rotated with its one end close to the pulling spring 16 being a supporting point as shown in FIG. 6B, which completes separating of PDP 1 of PDP unit 6 from chassis 4. After that, door 11b of separating device 11 is opened, and separated PDP 1 and chassis 4 are extracted from the inside of body unit casing 11a, which completes the dismantling process.

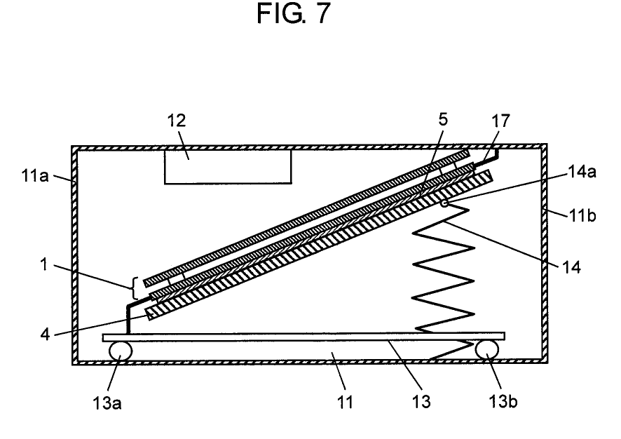

Another configuration as shown in FIG. 7 may be used. That is, holding base 13 has retaining fitting 17 retaining PDP unit 6 in an oblique state. Retaining fitting 17 retains PDP 1 of PDP unit 6 so that the chassis 4 side comes to the lower side. Further, pulling spring 14 is attached to the bottom surface of body unit casing 11a of separating device 11 so that chassis 4 of PDP unit 6 undergoes a downward urging force.

In this case, as a result that heating device 12 heats sheet 5 of PDP unit 6, the adhesivity of sheet 5 bonding PDP 1 to chassis 4 decreases, and when the sum of a peeling force by pulling spring 14 and a tensile force by the self weight of chassis 4 exceeds the adhesivity of sheet 5, chassis 4 is peeled off in a way chassis 4 is rotated with its one end being a supporting point, which completes separating of PDP 1 of PDP unit 6 from chassis 4. Hence, the separating work becomes easier.

In the embodiment hereinbefore, heating device 12 is placed inside separating device 11, where the heating device may be such as a heating tunnel furnace and heating batch furnace.

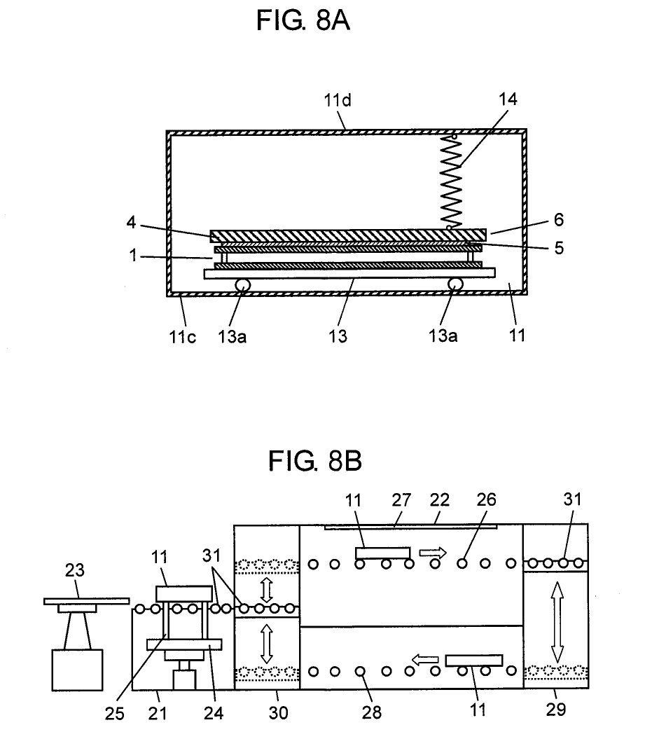

FIGS. 8A and 8B are outline block diagrams showing an exemplary embodiment in which heating device 12 is not placed in separating device 11, but a heating tunnel furnace is used.

First, as shown in FIG. 8A, separating device 11 includes a transfer unit composed of transfer base 11c on which holding base 13 for holding PDP 1 is placed; and angle 11d attached to transfer base 11c, onto which one end of pulling spring 14 is attached. Then, similarly to FIG. 4, pulling spring 14 of separating device 11 has fastening fitting 14a fastened to the end of chassis 4 of PDP unit 6 to exert an urging force caused by elastic weighting on chassis 4 in a direction such that PDP 1 is peeled off from chassis 4.

As shown in FIG. 8A, separating device 11 is transferred through a heating tunnel furnace as shown in FIG. 8B with PDP unit 6 placed on device 11 to heat sheet 5 of PDP unit 6, thereby separating PDP 1 from chassis 4.

In FIG. 8B, separating device transfer device 21 is placed at one side of heating furnace 22 to carry in and out separating device 11 at the same side of heating furnace 22. Separating device transfer device 21 is composed of transfer hand 23 for transferring separating device 11 when carrying separating device 11 into heating furnace 22; and hoist unit 24 for hoisting separating device 11 carried out from heating furnace 22 to receive device 11 by transfer hand 23.

Hoist unit 24 has plural hoist pins 25 for supporting separating device 11 at plural points. Hoist pin 25 moves up and down perpendicularly to hoist unit 24 to make the front end of hoist pin 25 touch transfer base 11c of separating device 11, thereby hoisting separating device 11 above the transfer surface. Heating furnace 22 has plural (two stages in the figure) stages vertically provided, where the upper stage contains transfer roller 26 and heating device 27 (e.g. a heater) and the lower stage contains carry-out roller 28. At the transfer endpoint of heating furnace 22 (i.e. at the side opposite to separating device transfer device 21), hoist device 29 is placed for moving separating device 11 from the upper stage to the lower. Further, at the side through which separating device 11 is carried into heating furnace 22, hoist device 30 is placed for moving separating device 11 from the lower stage to the upper. Each of separating device transfer device 21, and hoist devices 29 and 30 includes transfer roller 31.

In the example of FIG. 8B, separating device 11 with PDP unit 6 placed therein is sent into heating furnace 22, transferred inside heating furnace 22 by the rotation of transfer roller 26 to undergo a heating process by PDP unit 6. As a result that heating device 28 heats sheet 5 of PDP unit 6, the adhesivity of sheet 5 bonding PDP 1 to chassis 4 decreases, and when a peeling force by pulling spring 14 exceeds the adhesivity of sheet 5, chassis 4 is peeled off, which completes separating of PDP 1 of PDP unit 6 from chassis 4.

Separating device 11 after completing separation is lowered by hoist device 29 and is returned to the carry-in side of heating furnace 22 by carry-out roller 28 provided in the lower stage inside heating furnace 22. Separating device 11 that has returned to the carry-in side is raised by hoist device 30 and is returned to separating device transfer device 21. Subsequently, device 11 is extracted from transfer roller 31 by hoist unit 24, which completes the separation process.

In the example of FIGS. 8A and 8B, each separating device 11 with PDP unit 6 placed therein is sequentially inserted into heating furnace 22 to allow PDP 1 to be separated from chassis 4 automatically, thereby making a dismantling process more efficiently.

As described above, the present invention provides the following method. That is, when peeling off PDP 1 from chassis 4, sheet 5 of PDP unit 6 is heated in a state in which either one of PDP 1 and chassis 4 is fixed and the other is undergoing an urging force caused by elastic weighting in a direction such that PDP 1 is peeled off from chassis 4, thereby efficiently separating PDP 1 from chassis 4 without requiring accurately adjusting heating temperature and heating time for each product.

As described in the above embodiment, PDP 1 can be separated from chassis 4 automatically using such as a heating tunnel furnace, making a separation process more efficiently.

As described above, according to the technology disclosed herein, the invention is useful in recycling PDPs.

1. A method of dismantling a plasma display device including a plasma display panel unit produced by bonding a plasma display panel to a support member through a bonding member, wherein the bonding member of the plasma display panel unit is heated when the plasma display panel is peeled off from the support member, in a state in which either one of the plasma display panel and the support member is held and the other is undergoing an urging force in a direction such that the plasma display panel is peeled off from the support member.

2. The method of dismantling a plasma display device, of claim 1, wherein a pulling spring is used for a means of exerting an urging force in a direction such that the plasma display panel is peeled off from the support member.

3. The method of dismantling a plasma display device, of claim 1, wherein an urging force is exerted in a direction such that the plasma display panel is peeled off from the support member with one end of the support member being a supporting point.

4. The method of dismantling a plasma display device, of claim 1,
wherein urging forces are exerted on both ends of the support member in a direction such that the plasma display panel is peeled off from the support member, and
wherein the urging forces are different from each other.

5. An apparatus of dismantling a plasma display device including a plasma display panel unit produced by bonding a plasma display panel to a support member through a bonding member, comprising:
a separating device in which the plasma display panel unit is placed; and
a heating device for heating the plasma display panel unit,
wherein the separating device includes:
a holding base for holding either one of the plasma display panel and the support member; and
an urging means for exerting an urging force on the other in a direction such that the plasma display panel is peeled off from the support member, and
wherein the heating device heats the bonding member of the plasma display panel unit in a state in which the plasma display panel unit is placed in the separating device by fixing either one of the plasma display panel and the support member to the holding base and by attaching the urging means to the other.

6. The apparatus of dismantling a plasma display device, of claim 5, wherein a pulling spring is used as an urging means of the separating device.

7. The apparatus of dismantling a plasma display device, of claim 5, wherein the separating device is configured to use one end of the support member as a supporting point and to attach an urging means to the other end.

8. The apparatus of dismantling a plasma display device, of claim 5, wherein the separating device is configured to attach urging means with different urging forces to both ends of the support member.
